(19) United States
(12) Patent Application Publication
(10) Pub. No.: US 2015/0260619 A1
(43) Pub. Date: Sep. 17, 2015

(54) Method and Device for Processing Histological Tissue Samples

(71) Applicant: MEDITE GMBH, Burgdorf (DE)

(72) Inventors: Michael Ott, Burgdorf (DE); Michaela Ott, Burgdorf (DE); Thomas Gunkel, Weinhausen (DE)

(21) Appl. No.: 14/433,607

(22) PCT Filed: Sep. 27, 2013
(86) PCT No.: PCT/DE2013/000547

§ 371 Date: Apr. 3, 2015

(30) Foreign Application Priority Data
Oct. 4, 2012 (DE) 10 2012 019 438.2

(51) Int. Cl. G01N 1/30; G01N 35/00; G01N 35/04; G01N 1/28; G01N 1/31

(52) U.S. Cl. CPC G01N 1/30; G01N 1/286; G01N 1/312; G01N 35/04; G01N 35/00029; G01N 35/0099; G01N 2001/2886; G01N 2035/0441; G01N 2035/0465; G01N 2035/00168; G01N 2035/00138

(57) ABSTRACT

The invention relates to a method and to a device for processing histological tissue samples, in which tissue samples are cut and subsequently further processed on a specimen slide in an automated process. According to the invention an automation shall be achieved that is as complete as possible by moving the tissue samples in an automatic process from one process step to the next; in said process first of all a specimen slide printed on which automatically readable information is printed is supplied, a tissue sample is placed on said specimen slide, the tissue sample on the specimen slide is cut, the residual tissue is removed from the specimen slide, at least one more processing step of the tissue sample is carried out on the specimen slide and subsequently the specimen slide including the processed sample is discharged from the automatic process.

### BACKGROUND OF THE INVENTION

1. Field of the Invention

The invention relates to a method for processing histological tissue samples, in which tissue samples are cut and subsequently further processed on specimen slides in an automated process. The invention further relates to a device for processing histological tissue samples.

2. Brief Discussion of the Related Art

A method and a device of the type named in the introduction are known from EP 1 811 281 B1. In this publication, the sample recovery, the processing, the staining, the interpreting and the storing are described. The transport between the individual stations can be carried out in any form, for example by robots from one station to the next or also by hand.

### BRIEF SUMMARY OF THE INVENTION

The invention is based on the problem of creating an automation which is as complete as possible of the processing of histological tissue samples.

In a method for processing histological tissue samples, in which tissue samples are cut and subsequently further processed on specimen slides in an automated process, provision is made in a manner essential to the invention that a method is carried out with steps in the following sequence:

a) supplying of a specimen slide on which automatically readable information is printed,

b) placing of a tissue sample onto the specimen slide,

c) cutting of the tissue sample on the specimen slide with a laser microtome,

d) removing of the residual tissue from the specimen slide,

e) carrying out at least one further processing step of the tissue sample on the specimen slide,

f) discharging of the specimen slide with the processed sample in an archive,

wherein all the above-mentioned working steps are carried out on the same specimen slide and the specimen slide is moved in an automated manner from one process step to the next process step.

Through the continuous use of a single specimen slide, an automation which is as complete as possible of the method can take place. The specimen slide is preferably a conventional specimen slide made of glass, but can basically also have any other form which fulfils the requirement that the tissue sample can be held, processed and transported on this specimen slide. The printing of the specimen slide can take place either after the introduction of the specimen slide into the automatic process, or can take place in advance in a process step, and the specimen slide is then introduced into the automated process sequence. The automatically readable information is preferably applied in the form of a barcode. The information preferably contains individual patient information and information concerning the processing of the sample, in particular concerning the cuts which are to be carried out, the staining protocol and all the processing steps.

The automatic further movement of the specimen slides takes place in the manner of a conveyor belt principle, so that during a processing phase each station is occupied by a specimen slide and the sample which is to be processed. After processing, a further transportation takes place to the respectively next station, so that in the subsequent processing phase all the stations are again occupied by a specimen slide and a sample lying thereon. For a greatest possible efficiency, therefore, the individual processing steps are designed so that they require approximately the same amount of time. The entire processing time is determined definitively by the processing step which requires the longest time, because the overall process is oriented thereto. Preferably, therefore, the further processing steps of the tissue sample on the specimen slide are distributed to several positions so that the individual processing steps require as far as possible comparatively little time and the duration for a processing step is determined by the duration of the steps b, c and d.

In a preferred embodiment, fresh tissue is processed. This means that non-fixed tissue, which is not paraffinized, is placed onto the specimen slide and further processed. The cutting with the laser microtome also takes place on the fresh tissue. Thereby, a series of steps, such as the dehydration and the paraffinizing and further additional steps can be dispensed with.

In a preferred embodiment of the invention, the specimen slides are moved on a revolving path, preferably on a circular path. For this, a conveying arrangement is provided, on which the specimen slides rest and are transported in a revolving manner from one process step to the next. In another preferred embodiment of the invention, the specimen slides are directed linearly. This means that a conveying arrangement in the manner of a conveyor belt is provided, which moves the specimen slides from one process step to the next step. At the beginning, for this, a specimen slide is put in place and at the end is removed from the linear path and deposited in the archive. The path can then run back on the underside in the manner of a conveyor belt. A range of other embodiments is also conceivable. In a particularly preferred embodiment, the specimen slides are moved on a rotary plate from one process step to the next.

The placing of the tissue sample onto the specimen slide takes place particularly preferably with a three-armed gripper, with which preferably the sample is removed by a receiving head or a stamp from a dish filled with storage fluid and with the sample. The specimen slide was previously printed with an automatically readable information code, in particular a barcode, which contains the relevant information concerning this tissue sample. The receiving head grips the sample here either with a vacuum gripper, in particular with a vacuum tube, or with an adhesive arrangement, in particular an adhesive tape operating on an albumen basis, wherein the adhesive tape is preferably renewed with each sample, in particular is constructed as a continuously rolling adhesive tape. The positioning takes place here by a computer-assisted image recognition system.

The tissue sample is cut on the specimen slide. Basically, any type of cutting arrangement can be used here. In a preferred embodiment, a laser microtome is used. Such a laser microtome is described for example in EP 1 945 401 B1. In the case of more than one cut, the tissue is lifted again and placed onto the next specimen slide. In the case of pre-cuts, the specimen slide is ejected. The corresponding information concerning the number of cuts is situated on the specimen slide with the automatically readable information. The residual tissue is placed by the gripper arrangement back into the receiving container which is filled with fluid. Preferably, the cutting with the laser microtome takes place from below through the specimen slide. The laser beam is focussed such that it develops its cutting effect at a particular depth in the tissue. The beam is moved in accordance with the desired cutting area and in this way a horizontal cut is produced.

The at least one further processing step which is then carried out preferably contains the staining of the sample. This takes place at a defined position on the further-transported specimen slide. In another preferred embodiment of the invention, the at least one further processing step contains the flushing of the tissue sample. Furthermore, a mounting medium is applied as a further processing step. A further possible processing step is the mounting of the processed sample with a cover medium, e.g. a cover film, a cover lacquer or a cover slip. Various combinations of the individual processing steps can be carried out here. In particular also several processing steps can take place in which a flushing is carried out or several different staining processes can be carried out. In a preferred embodiment of the invention, the said processing steps are all carried out. The information with regard to the processing steps which are to be carried out is contained in the automatically readable information which is associated with the sample. Thereafter, the specimen slides with the processed sample are discharged from the automatically revolving transport zone. The samples can now be supplied for analysis or for a further processing.

In a preferred working step, the specimen slide with the processed sample is stored in an archive. The archive is preferably configured as an archive basket. By a storage in an archive or archive basket, it is possible to process a plurality of histological samples in the specimen slide automatically continuously and after a certain time to then exchange the archive basket with the samples contained therein for a new archive basket and to supply the samples for further analysis or other applications.

A further aspect of the invention consists in the provision of a device for processing histological tissue samples, in particular for carrying out the method described above, wherein the device has the following components:

a) an arrangement for the automatic transport of specimen slides, on which the tissue samples are deposited,

b) a specimen slide printer, for printing the specimen slides with a machine-readable code,

c) a transfer device for receiving the tissue samples and for placing onto one of the specimen slides,

d) a laser microtome for cutting the tissue samples on the specimen slide,

e) at least one processing arrangement for carrying out a further processing step of the tissue sample on the specimen slide,

f) an exit station for discharging the specimen slide with the processed sample from the arrangement for automatic transport.

In a preferred embodiment of the invention, the arrangement for automatic transport of the specimen slides is constructed as a rotary plate. On this rotary plate, a plurality of defined mounts for the individual specimen slides is preferably provided. In particular, an entry station and an exit station are provided, at which the specimen slides are firstly supplied to the arrangement for automatic transport and at the end, on completion of the processing, are discharged. The entry station is preferably constructed in combination with the specimen slide printer, so that specimen slides with a machine-readable code printed thereon are introduced to the arrangement for automatic transport. The specimen slide printer can either be arranged in the device so that it prints the specimen slides before they are deposited onto the arrangement, or the specimen slide printer can be positioned within the device such that it prints the specimen slides after they are deposited on the arrangement for automatic transport, in particular on the rotary plates. At the exit station, the finished processed histological samples are discharged and are preferably stored in an archive, in particular in an archive basket. The arrangement for automatic transport of the specimen slides can either be a rotary plate or another type of automated arrangement which directs the specimen slides in a revolving path, in particular a circular path. Alternatively, it can also be a type of conveyor belt with an upper run and a lower run, wherein the processing stations are then of course arranged along the upper run. The device preferably has furthermore a microtome, in particular a laser microtome, by which the samples on the tissue slide can be cut. With such a laser microtome it is possible to direct a cut parallel to the specimen slide. The laser microtome is preferably positioned so that it can beam through the specimen slides from below. The specimen slides in the arrangement for automatic transport are preferably placed in a mount which leaves a free opening beneath the specimen slide, so that the laser can penetrate from below through the specimen slide and by a corresponding focussing and then horizontal displacement of the laser beam achieves a horizontal cut in the tissue sample. The tissue sample is preferably a non-fixed, non-paraffinized tissue sample. With the device according to the invention preferably non-treated, fresh tissue can be handled, cut, processed and supplied for a further evaluation.

A further essential component of such a device is the transfer device for receiving the tissue samples and for placing onto a specimen slide. This is preferably constructed as a robot, in particular as a robot with a gripper arm. The gripper arm can preferably receive the samples with a vacuum tube or with an adhesive arrangement and supply them to a specimen slide on the arrangement for automatic transport. The sample is then cut with the microtome. The transfer device can then receive residues on the next station and either discard these or set them aside into a corresponding receiving dish. The device according to the invention preferably has further arrangements such as one or more dispensers, by which chemicals, stains or flushes are supplied for further processing of the tissue samples. Furthermore, the device preferably has a covering arrangement, by which the specimen slides are covered with a cover slip.

### BRIEF DESCRIPTION OF THE DRAWINGS

The invention is explained below with the aid of a preferred example embodiment, illustrated in the drawings. In detail, the diagrammatic illustrations show in:

FIG. 1 is a diagrammatic view of a device according to the invention;

FIG. 2 is a view of a transfer device of the device according to the invention; and

FIG. 3 is a portion of the transfer device of FIG. 2, illustrated on an enlarged scale.

### DETAILED DESCRIPTION OF THE PREFERRED EMBODIMENTS

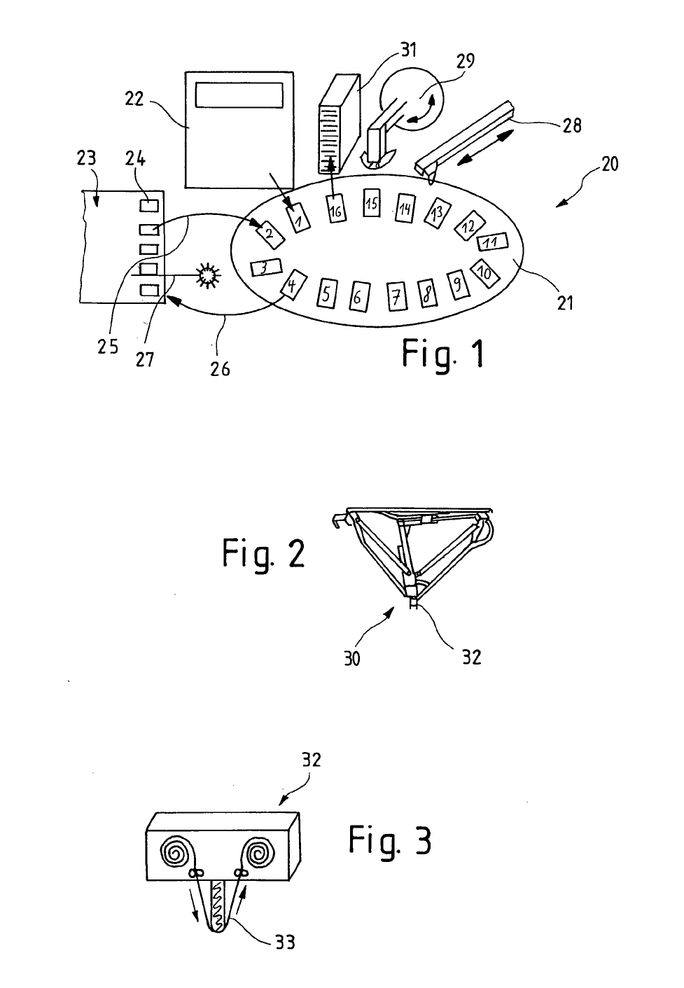

In FIG. 1 a device 20 according to the invention is illustrated, which has as central component a rotary plate 21 which forms the arrangement for the transport of the specimen slides. In the illustrated example embodiment, sixteen positions are provided on the rotary plate 21, on which positions respectively a specimen slide lies. The position 1 forms the entry station at which a specimen slide is placed onto the rotary plate 21. The specimen slide is printed there, or in a parallel specimen slide printer 22 the specimen slide is printed and then placed in printed form onto the rotary plate 21. The specimen slides lie on the rotary plate in the margin regions. Beneath the specimen slides there is a free opening in wide regions in the rotary plate, so that a free access exists there in particular for the laser microtome.

A plurality of dishes 24 with samples contained therein is supplied on a rack 23. These samples have been appraised macroscopically and the number of cuts to be executed is established and recorded on a code associated with the sample. A corresponding machine-readable code, in particular a barcode, of the information concerning the sample which is to be practically received and concerning the processing steps which are to be carried out, is printed onto the specimen slide by the specimen slide printer 22 in the form of a barcode. The specimen slide is then transported further automatically by the rotary plate 21 or by a differently designed fully automatic arrangement for automatic transport. At the position marked here by 2, a sample is removed from the rack 23 of receiving dishes 24 and is placed onto the specimen slide 2. This is indicated by the arrow 25. The execution takes place by a transfer device 30, described further in FIGS. 2 and 3, for receiving the tissue samples and for placing onto the specimen slide at position 2. The tissue sample is then transported further and at position 3 a cut takes place with the microtome, marked by 27, which is constructed here as a laser microtome. A horizontal cut takes place, and after further transport to position 4, the residual tissue is removed by means of the transfer device 30 and is directed back to the rack 23 into a dish 24. This is indicated here by the arrow 26. When it is recorded in the machine-readable information that this tissue sample is to be cut several times, the tissue is lifted at position 4 and placed onto the carrier at position 2 and is then cut again. In this case, owing to the machine-readable information, of course previously no occupying of the specimen slide at position 2 with a new tissue sample takes place. The tissue samples which lie on the specimen slides undergo further processing steps at positions 5 to 13. The tissue sample is processed with staining and flushing cassettes or with other techniques for the supplying of chemicals or colorants. In particular, rapid stainings are used here, which can take place within three minutes. At position 14 a covering medium is applied onto the specimen slide by means of a dispenser 28, which is also movable. At position 15, a cover slip is brought onto the specimen slide by a covering arrangement. At position 16 an exit station is present, at which the specimen slide is discharged out from the processing cycle and is stored in an archive basket 31.

In FIG. 2 the transfer device 30 is illustrated diagrammatically, which is constructed here preferably as a three-armed gripping robot. At the actual receiving head 32 either a vacuum tube is provided or a receiving head 32 illustrated in FIG. 3, which operates substantially as a stamp and has an adhesive tape 33, in particular an albumen adhesive tape, continuing to roll on with each sample.

1. A method for processing histological tissue samples, in which tissue samples are cut and subsequently further processed on specimen slides in an automated process,
comprising the following process steps:
a) supplying of a specimen slide on which automatically readable information is printed,
b) placing of a tissue sample onto the specimen slide,
c) cutting of the tissue sample on the specimen slide with a laser microtome,
d) removing of the residual tissue from the specimen slide,
e) carrying out at least one further processing step of the tissue sample on the specimen slide,
f) discharging of the specimen slide with the processed sample;
wherein all the above-mentioned working steps are carried out on the same specimen slide and the specimen slide is moved in an automated manner from one process step to the next process step.

2. The method according to claim 1, wherein the individual process steps require approximately the same duration.

3. The method according to claim 1, wherein non-paraffinized tissue samples are used.

4. The method according to claim 1, wherein the tissue samples on the specimen slide are cut with a laser microtome from below through the specimen slide.

5. The method according to claim 1, wherein the specimen slides are moved on a revolving path.

6. The method according to claim 1, wherein the specimen slides are directed linearly.

7. The method according to claim 1, wherein the further processing step (e) contains the staining of the sample.

8. The method according to claim 1, wherein the further processing step e) is the flushing of the tissue sample.

9. The method according to claim 1, wherein the further processing step e) is the application of a covering medium.

10. The method according to claim 1, wherein the further processing step e) is the covering of the processed sample.

11. A device for processing histological tissue samples, in particular for carrying out the method according to claim 1, wherein the device has the following components, wherein in an entry station the specimen slides are passed to the arrangement for transport:
a) an arrangement for the automatic transport of specimen slides, on which the tissue samples are deposited,
b) a specimen slide printer, for printing the specimen slides with a machine-readable code,
c) a transfer device for receiving the tissue samples and for placing onto a specimen slide,
d) a laser microtome for cutting the tissue sample on the specimen slide,
e) at least one processing arrangement for carrying out a further processing step of the tissue sample on the specimen slide,
f) an exit station for discharging the specimen slide with the processed sample from the arrangement for automatic transport.

12. The device according to claim 11, wherein the arrangement for automatic transport of the specimen slides is a rotary plate.

13. The device according to claim 11, wherein the transfer device for receiving the tissue samples is a robot arm with a receiving head.

14. The device according to claim 12, wherein the laser microtome is directed from below onto the specimen slides.

15. The device according to claim 11, wherein an archive is provided for receiving the processed tissue samples.
